(19) United States
(12) Patent Application Publication
(10) Pub. No.: US 2015/0237636 A1
(43) Pub. Date: Aug. 20, 2015

(54) WIRELESS MESH NETWORK SCHEDULING METHOD BASED ON BIO-INSPIRED ALGORITHM AND SYSTEM THEREFOR

(71) Applicant: Korea Advanced Institute of Science and Technology, Daejeon (KR)

(72) Inventors: Hong Shik PARK, Daejeon (KR); Jun Seop AHN, Daejeon (KR); Eun Jung LEE, Daejeon (KR)

(21) Appl. No.: 14/621,735

(22) Filed: Feb. 13, 2015

(30) Foreign Application Priority Data
Feb. 20, 2014 (KR) 10-2014-0019462
Jun. 3, 2014 (KR) 10-2014-0067524

(51) Int. Cl. H04W 72/08; H04L 5/00; H04W 72/12

(52) U.S. Cl. CPC H04W 72/082; H04W 72/1263; H04L 5/0078; H04W 84/18

(57) ABSTRACT

A wireless mesh network (WMN) scheduling method based on a bio-inspired algorithm is provided. The WMN scheduling method includes updating statistic information about channel occupancy statuses and statistic information about channel assignment determination maximum values through an ant packet, assigning a channel, which meets secondary interference constraint, using the channel assignment determination maximum values and assigning a link activation time, and repeatedly performing the processing from the updating of the statistic information until the channel is assigned to all links of a node.

### CROSS-REFERENCE TO RELATED APPLICATIONS

A claim for priority under 35 U.S.C. §119 is made to Korean Patent Application No. 10-2014-0019462 filed Feb. 20, 2014, and Korean Patent Application No. 10-2014-0067524 filed Jun. 3, 2014, in the Korean Intellectual Property Office, the entire contents of which are hereby incorporated by reference.

### BACKGROUND

Embodiments of the inventive concepts described herein relate to a wireless mesh network (WMN) scheduling method based on a bio-inspired algorithm and a system therefor, and more particularly, to a WMN scheduling method based on a bio-inspired algorithm and a system therefor to give a scheduling priority to a priority frame, thereby meeting a delay request condition for frame transmission.

A WMN is a form of a multi-hop Ad Hoc network which receives traffics through the Internet or transmits traffics to the Internet. The WMN is a wireless network which includes mesh nodes and mesh clients. Herein, each of the mesh nodes performs an additional routing function which supports mesh networking as well as a typical routing function for gateway and bridge functions such as a typical wireless router. Each of the mesh nodes has minimum mobility and plays a pivotal role which forms a mesh backbone for mesh clients.

However, these configurations of the WMN have an influence on mesh capacity in the WMN due to interference caused from neighbor nodes in the WMN. To solve this capacity problem, there are a plurality methods, such as a method using a corrected media access control (MAC) protocol applied to the WMN, a method using a change in channel in single radio, and a method using a directional antenna.

In Korean Patent No 10-1158974, a method of assigning channels in a wireless mesh node having multi-radio is provided. The description is given for a method of assigning a candidate channel selected by discriminating a channel status using channel status information and channel listening information of neighbor nodes within a certain hop, which are collected from the neighbor nodes.

However, in a channel assignment method using channel occupancy information and link status information such as a received signal strength indicator (RSSI) value, a priority assignment scheme to a channel with a good link status may not maximize frequency efficiency.

### SUMMARY

Embodiments of the inventive concepts provide a wireless mesh network (WMN) scheduling method based on a bio-inspired algorithm and a system therefor to improve spectral efficiency through efficient channel assignment by performing channel assignment based on a link weight, which meets secondary interference constraint, using the bio-inspired algorithm and activating links by the number of requested transmission frames.

Embodiments of the inventive concepts provide a wireless mesh network (WMN) scheduling method based on a bio-inspired algorithm and a system therefor to give a scheduling priority to a priority frame, thereby meeting a delay request condition for frame transmission.

One aspect of embodiments of the inventive concept is directed to provide a wireless mesh network (WMN) scheduling method based on a bio-inspired algorithm. The WMN scheduling method may include updating statistic information about channel occupancy statuses and statistic information about channel assignment determination maximum values through an ant packet, assigning a channel, which meets secondary interference constraint, using the channel assignment determination maximum values and assigning a link activation time, and repeatedly performing the processing from the updating of the statistic information until the channel is assigned to all links of a node.

The updating of the statistic information about the channel occupancy statuses and the statistic information about the channel assignment determination maximum values through the ant packet may include calculating the channel assignment determination maximum values, acquiring the channel occupancy statuses and the channel assignment determination maximum values of nodes within three hops through the ant packet, and updating the statistic information about the channel occupancy statuses and the statistic information about the channel assignment determination maximum values.

The assigning of the channel, which meets the secondary interference constraint, using the channel assignment determination maximum values and the assigning of the link activation time may include determining whether the channel is assigned to the greatest value in the statistic information about the channel assignment determination maximum values, determining whether there is the channel which meets the secondary interference constraint, assigning the channel, which meets the secondary interference constraint, a link having the maximum assignment determination maximum value, assigning the link activation time on a frame-by-frame basis, and transmitting frames.

The assigning of the channel, which meets the secondary interference constraint, using the channel assignment determination maximum values and the assigning of the link activation time may include assigning the channel based on a link weight.

The assigning of the channel based on the link weight may include calculating a transmission frame weight and a priority frame weight, calculating a link weight based on the transmission frame weight and the priority frame weight, and updating the link weight according to a change in a beacon interval period and a change in the number of frames which are accumulated in queues.

Another aspect of embodiments of the inventive concept is directed to provide a wireless mesh network (WMN) scheduling system based on a bio-inspired algorithm. The WMN scheduling system may include an ant generating and analyzing unit configured to generate and analyzing an ant, a channel occupancy status statistic unit configured to update information about channel occupancy statuses through the ant generating and analyzing unit, a channel assignment determination maximum value statistic unit configured to calculate and update channel assignment determination maximum values, a channel assigning unit configured to a channel, which meets secondary interference constraint, using the channel occupancy statuses and the channel assignment determination maximum values, and a link scheduler configured to assign a link activation time of a link to which the channel is assigned by the channel assigning unit.

The WMN scheduling system may further include a local statistic unit configured to acquire information about neighbor nodes, generate statistic information, and provide the statistic information to the channel assigning unit.

The WMN scheduling system may further include a link weight calculating unit configured to calculate a link weight using a transmission frame weight and a priority frame weight, wherein the channel assignment determination maximum value statistic unit updates the channel assignment determination maximum values based on the link weight calculated by the link weight calculating unit.

The channel assignment determination maximum value statistic unit may calculate the channel assignment determination maximum values, may acquire the channel assignment determination maximum values of nodes within three hops through an ant packet, and may update statistic information about the channel assignment determination maximum values.

The channel assigning unit may verify whether the channel is assigned to the greatest value in the channel assignment determination maximum value statistic unit, may verify whether there is the channel which meets the secondary interference constraint, and may assign the channel, which meets the secondary interference constraint, to a link having the channel assignment determination maximum value.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a drawing illustrating a configuration of mesh nodes according to an exemplary embodiment of the inventive concept;

FIG. 2 is a flowchart illustrating a weight calculation method according to an exemplary embodiment of the inventive concept;

FIG. 3 is a flowchart illustrating a link weight calculation and update method according to an exemplary embodiment of the inventive concept;

FIG. 4 is a drawing illustrating ant colony optimization (ACO) according to an exemplary embodiment of the inventive concept;

FIG. 5 is a drawing illustrating a format of an ant packet according to an exemplary embodiment of the inventive concept;

FIG. 6 is a flowchart illustrating a wireless mesh network (WMN) scheduling method based on a bio-inspired algorithm according to an exemplary embodiment of the inventive concept;

FIG. 7 is a flowchart illustrating a wireless mesh network (WMN) scheduling method based on a bio-inspired algorithm according to an exemplary embodiment of the inventive concept;

FIG. 8 is a drawing illustrating a secondary interference constraint according to an exemplary embodiment of the inventive concept; and

FIG. 9 is a flowchart illustrating a WMN scheduling system based on a bio-inspired algorithm according to an exemplary embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Hereinafter, a description will be given in detail for exemplary embodiments of the inventive concept with reference to the accompanying drawings.

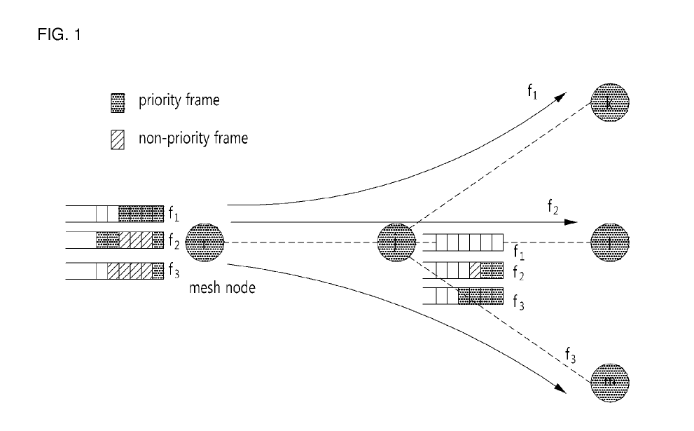

FIG. 1 is a drawing illustrating a configuration of mesh nodes according to an exemplary embodiment of the inventive concept.

Referring to FIG. 1, a mesh node in a wireless mesh network (WMN) may transmit frames which may be classified into priority frames and non-priority frames. The mesh node may give a scheduling priority to the priority frame, thereby meeting a delay request condition for frame transmission. Herein, a routing path about flow may be given.

The WMN may include a plurality of mesh nodes and mesh gateways. This WMN may be connected with an application system through an internet protocol (IP) network which is connected with the mesh gateways. The mesh gateway may perform a function of transmitting traffics of a user, who is connected to the WMN, to an IP backbone network or transmitting traffics in the opposite direction.

Also, the mesh node may allow neighbor nodes, which are connected thereto, to be connected and may also allow a mesh client to be connected thereto among the mesh nodes other than it and the mesh gateways. The mesh node may have a certain wireless coverage. For example, the mesh node may allow the mesh client to be connected thereto, but may have a state where it is not connected with neighbor nodes or mesh gateways. Herein, two or more radio links may be set and maintained between mesh nodes.

Accordingly, the WMN may provide a path diversity from one certain point to another certain point through connection between mesh nodes, that is, a mesh link, and may assign channels to a plurality of mesh nodes for each link channel.

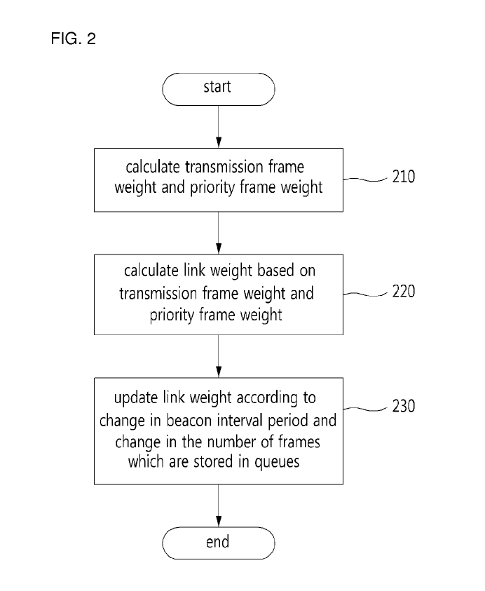

FIG. 2 is a flowchart illustrating a weight calculation method according to an exemplary embodiment of the inventive concept.

In step 210, a weight calculation system may calculate a transmission frame weight and a priority frame weight.

In step 220, the weight calculation system may calculate a link weight based on the transmission frame weight and the priority frame weight.

In step 230, the weight calculation system may update the link weight according to a change in a beacon interval period and a change in the number of frames which are accumulated in queues.

Hereinafter, a description will be given in detail for a weight calculation method.

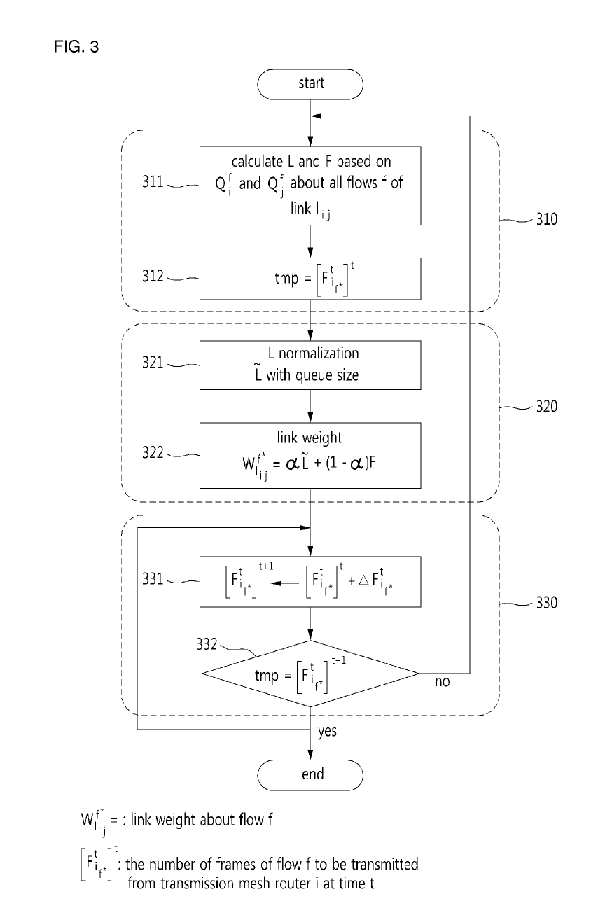

FIG. 3 is a flowchart illustrating a link weight calculation and update method according to an exemplary embodiment of the inventive concept.

Referring to FIG. 3, a description will be given in detail for the method of calculating the weight in FIG. 2.

In step 310, a weight calculating system may calculate a transmission frame weight and a priority frame weight.

Herein, the transmission frame weight may be a weight of a flow having the greatest difference between the number of transmission frames and the number of reception frames among flows of links between a transmission mesh router and a reception mesh router.

In more detail, in step 311, the transmission frame weight may be calculated according to Equation 1 below.

$$L = {max}_{∀ f : f ∈ {F}_{lij}} {⌊ {Q}_{i}^{f} - {Q}_{j}^{f} ]}^{t} \qquad [ Equation 1 ]$$

Herein, f may represent a flow which performs communication connection between certain two mesh routers. It may be assumed that each mesh router manages queues according to flows and there are a variety of traffics in each flow. Also, Fₜ_{ᵢⱼ} may represent a set of all flows which pass through a link I=(I, j). Qᵢ^{f} may represent the number of frames, which are accumulated in queues, with respect to the flow f from a transmission mesh router i to a reception mesh router j. Qⱼ^{f} may represent the number of frames, which are accumulated in queues, with respect to the flow f which is received at a reception mesh router j from the transmission mesh router i.

The priority frame weight may be a weight according to a ratio of high priority frames to frames, to be transmitted by the transmission mesh router i, with respect to a flow f* which defines the transmission frame weight of the link lᵢⱼ.

In more detail, in step 311, the weight calculation system may calculate the priority frame weight according to Equation 2 below.

$$F = \frac{{F}_{if *}^{h}}{{F}_{if *}^{t}} where {f}^{*} = argmax L \qquad [ Equation 2 ]$$

Herein, F_{if}^{h}* may represent the number of all frames of the flow f*, to be transmitted by the transmission mesh router i, and F_{if}^{t}* may represent the number of priority frames of the flow f*, to be transmitted by the transmission mesh router i.

In step 312, the weight calculation system may calculate the number of priority frames of the flow*, which are transmitted by the transmission mesh router I, at t time, that is, a beacon interval period.

In step 320, the weight calculation system may calculate a link weight based on the transmission frame weight and the priority frame weight.

Herein, the link weight may be a weight of the link about the flow f* based on the transmission frame weight and the priority frame weight.

In more detail, in step 321, the weight calculation system normalizes the transmission frame weight L to obtain the link weight. In step 322, the weight calculation system may calculate the link weight according to Equation 3 below.

wₗ_{ᵢⱼ}^{f}*=α\tilde{L}+(1−α)F [Equation 3]

wₗ_{ᵢⱼ}^{f}* may represent a weight of the link lᵢⱼ about the flow f*, \tilde{L} may represent normalization of L about max(L, mⱼ) (herein, mⱼ is a queue size of a reception mesh node), and a may represent a weight for a weighted sum of the transmission frame weight and the priority frame weight.

In step 330, the weight calculation system may update the weight according to a change in a beacon interval period and a change in the number of frames which are accumulated in queues.

In more detail, in step 331, the weight calculation system may obtain the number of priority frames of the flow f*, to be transmitted by the transmission mesh router i, at a (t+1) time by adding the number of the priority frames of the flow f*, which is obtained in step 321, to the changed number of priority frames of the flow f*.

In step 332, obtaining the number of the priority frames of the flow f* at the (t+1) time, the weight calculation system repeats the processing from step 331. Meanwhile, not obtaining the number of the priority frames of the flow f* at the (t+1) time, the weight calculation system repeats the processing from step 311.

As such, the mesh node in the wireless mesh network may determine channel assignment by calculating the link weight according to the transmission frame weight and the priority frame weight. Also, the mesh node may give the scheduling priority to the priority frames, thereby meeting the delay request condition for frame transmission.

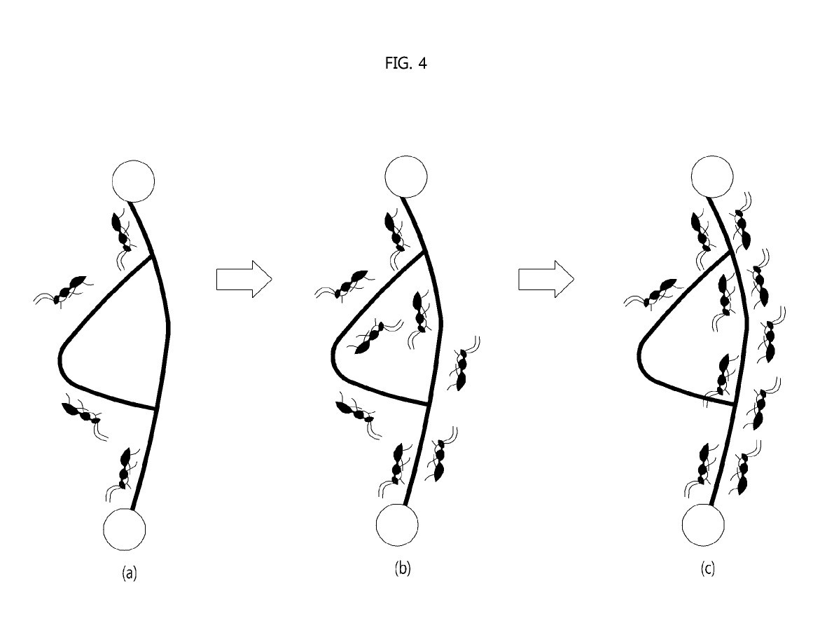

FIG. 4 is a drawing illustrating ant colony optimization (ACO) according to an exemplary embodiment of the inventive concept.

FIG. 4 illustrates activities for finding food of ants. There may be an algorithm of emulating the activities for finding food of ants and finding an optimal solution. Since a place through which ants frequently pass has a stronger pheromone flavor, a path with a strong pheromone flavor may be the shortest path.

Therefore, a wireless mesh network (WMN) scheduling method and a system therefor may emulate the activities for finding food of ants.

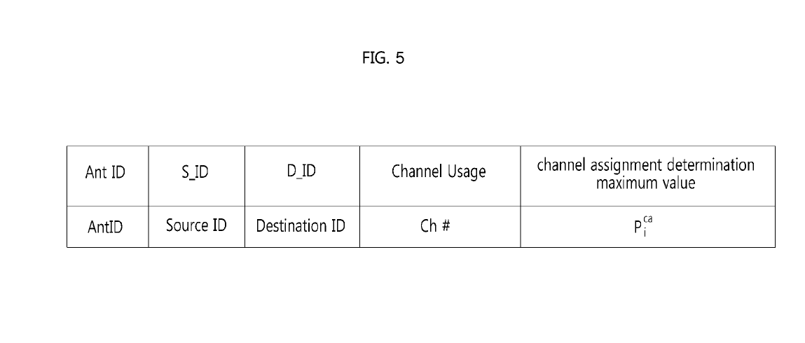

FIG. 5 is a drawing illustrating a format of an ant packet according to an exemplary embodiment of the inventive concept.

Referring to FIG. 5, the ant packet may include an ID (AntID) of an ant, a source ID (Source ID), a destination ID (Destination ID), a usage channel (Ch #), and a channel assignment determination maximum value (Pᵢ^{cα}).

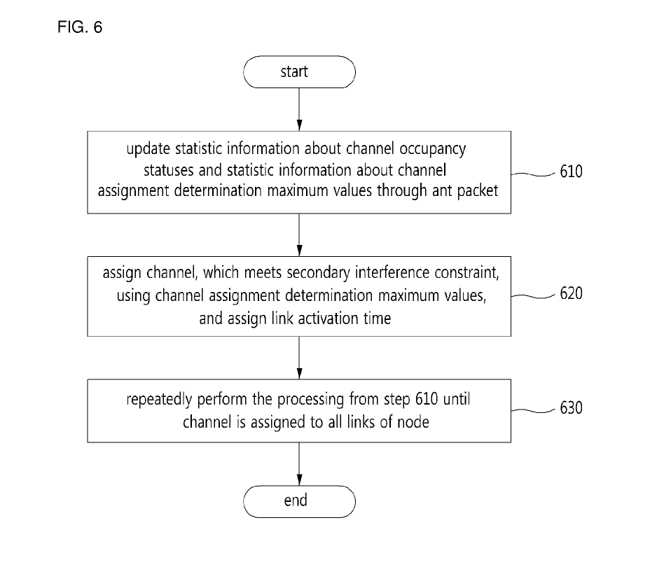

FIG. 6 is a flowchart illustrating a wireless mesh network (WMN) scheduling method based on a bio-inspired algorithm according to an exemplary embodiment of the inventive concept.

In step 610, a WMN scheduling system may update statistic information about channel occupancy statues and statistic information about channel assignment determination maximum values through an ant packet.

In step 620, the WMN scheduling system may perform a method of assigning a channel, which meets secondary interference constraint, using the channel assignment determination maximum values and may assign a link activation time.

Herein, the method of assigning the channel may be a method of assigning the channel based on a link weight. In other words, the method of assigning the channel based on the link weight may include calculating a transmission frame weight and a priority frame weight, calculating a link weight based on the transmission frame weight and the priority frame weight, and updating the link weight according to a change in a beacon interval period and a change in the number of frames which are accumulated in queues. The detailed description is given for this with reference to FIGS. 2 and 3, so no detailed description of this will be provided.

In step 630, the WMN scheduling system may verify whether the channel is assigned to all links of a node.

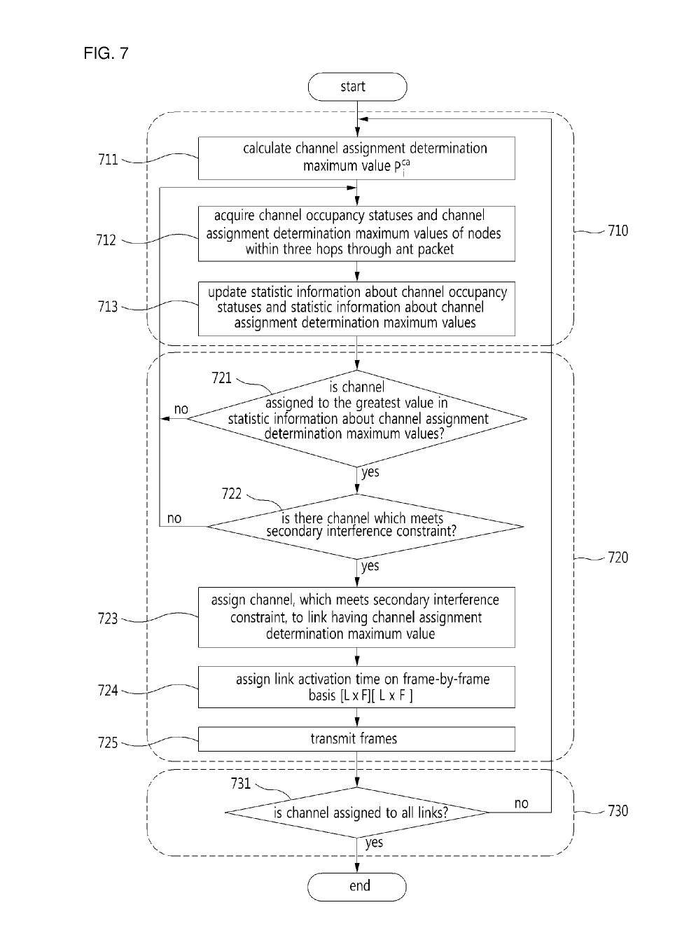

FIG. 7 is a flowchart illustrating a wireless mesh network (WMN) scheduling method based on a bio-inspired algorithm according to an exemplary embodiment of the inventive concept.

Referring to FIG. 7, a description will be given in detail for the WMN scheduling method of FIG. 6.

In step 710, the WMN scheduling system may update statistic information about channel occupancy statuses and statistic information about channel assignment determination maximum values.

In more detail, in step 711, the WMN scheduling system may calculate a channel assignment determination maximum value Pᵢ^{cα}. Herein, the channel assignment determination maximum value may be calculated according to Equation 4 below.

Pᵢ^{cα=max p}ᵢₖ^{cα},∀kεNᵢ [Equation 4]

where Nᵢ=set of neighbor of node i,

$${P}_{ik}^{ca} = \frac{{W}_{{l}_{ij}}^{f *}}{{\sum }_{∀ k} {W}_{{l}_{ik}}^{f *}}$$

Herein, Nᵢ may represent a set of neighbors of a node i.

Therefore, the channel assignment determination maximum value may be defined as a ratio of a weight of a link lᵢⱼ to a weight of all links of the node i. The higher the channel assignment determination maximum value, the higher a priority of channel assignment.

In step 712, the WMN scheduling system may acquire the channel occupancy statuses and the channel assignment determination maximum values of nodes within three hops through an ant packet.

In step 713, the WMN scheduling system may update statistic information about the channel occupancy states and statistic information about the channel assignment determination maximum values.

In step 720, the WMN scheduling system may assign a channel, which meets a secondary interference constraint, using the channel assignment determination maximum values, and may assign a link activation time.

In more detail, in step 721, the WMN scheduling system may determine whether the channel is assigned to the greatest value in the statistic information about the channel assignment determination maximum values.

When the channel is assigned to the greatest value in the statistic information, in step 722, the WMN scheduling system may determine whether there is the channel which meets the secondary interference constraint.

In step 723, the WMN scheduling system may assign the channel, which meets the secondary interference constraint, to a link having the channel assignment determination maximum value.

In step 724, the WMN scheduling system may assign the link activation time on a frame-by-frame basis.

Herein, the link activation time may be calculated according to Equation 5 below.

tₗ_{ᵢⱼ}=[L×F] [Equation 5]

In other words, the above-described link activation time may be a link activation time of a link lᵢⱼ to which a channel will be assigned.

In step 725, the WMN scheduling system may transmit frames.

In step 730, the WMN scheduling system may repeatedly perform the processing from step 710 until the channel is assigned to all links of the node.

In more detail, in step 731, the WMN scheduling system may verify whether the channel is assigned to all the links. The WMN scheduling system may repeatedly perform the processing from step 711 until the channel is assigned to all the links.

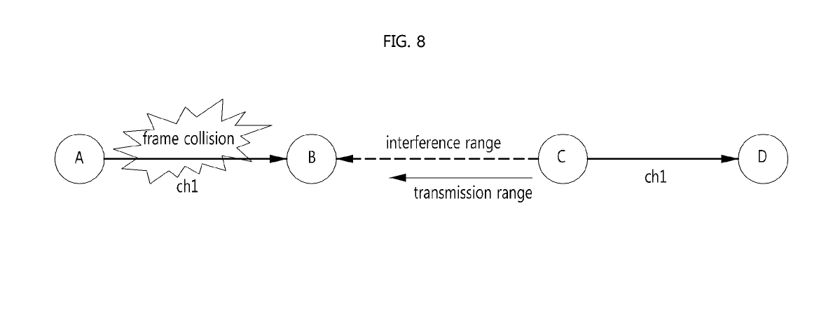

FIG. 8 is a drawing illustrating a secondary interference constraint according to an exemplary embodiment of the inventive concept.

Referring to 8, frame collisions may be frequently generated due to radio channel access control based on a distributed coordinated function (DCF). Accordingly, this may lead to deterioration in spectrum efficiency.

Also, secondary interference constraint may be that links using the same radio channel must be more distant from each other than a minimum of two hops.

An algorithm, which performs channel assignment based on a maximal weight, which meets the secondary interference constraint, and activates links by the number of requested transmission frames, may be configured using ant colony optimization (ACO).

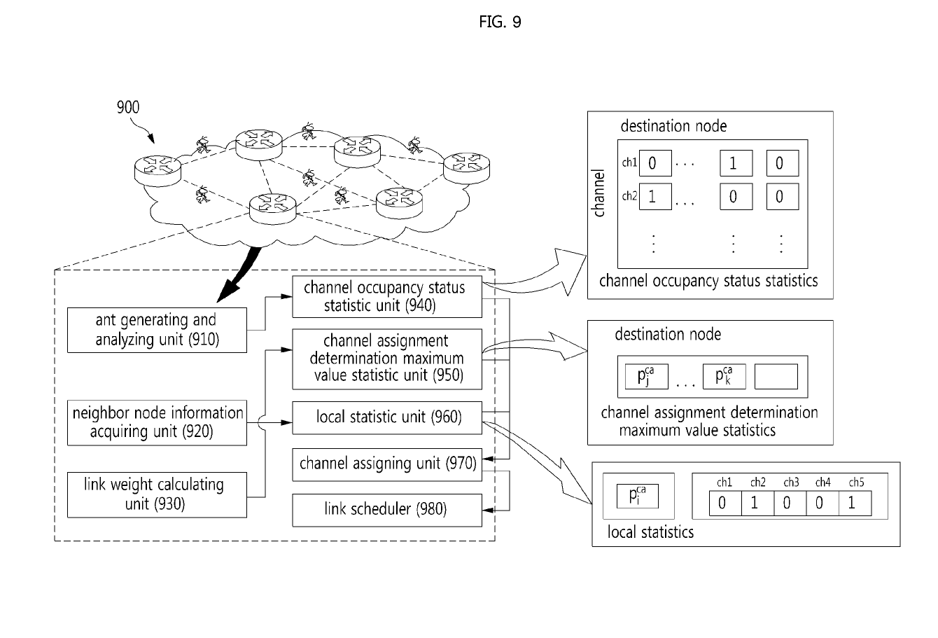

FIG. 9 is a flowchart illustrating a WMN scheduling system based on a bio-inspired algorithm according to an exemplary embodiment of the inventive concept.

Referring to FIG. 9, a configuration of one mesh node may be shown in a wireless mesh network (WMN) network 900. In other words, the WMN scheduling system based on the bio-inspired algorithm may include an ant generating and analyzing unit 910, a channel occupancy status statistic unit 940, a channel assignment determination maximum value statistic unit 950, a channel assigning unit 970, and a link scheduler 980.

The ant generating and analyzing unit 910 may configure the WMN scheduling system based on the bio-inspired algorithm by generating an ant and analyzing the generated ant.

As the ant generating and analyzing unit 910 analyzes the ant, the channel occupancy status statistic unit 940 may update channel occupancy status information.

The channel assignment determination maximum value statistic unit 950 may calculate and update channel assignment determination maximum values. Herein, the channel assignment determination maximum value statistic unit 950 may calculate the channel assignment determination maximum values, may acquire the channel assignment determination maximum values of nodes within 3 hops through an ant packet, and update statistic information about the channel assignment determination maximum values.

The channel assigning unit 970 may assign a channel, which meets secondary interference constraint, using the channel occupancy statuses and the channel assignment determination maxim values. Herein, the channel assigning unit 970 may verify whether the channel is assigned to the greatest value in the channel assignment determination maximum value statistic unit 950, may verify whether there is the channel which meets the secondary interference constraint, and may assign the channel, which meets the secondary interference constraint, to a link having the channel assignment determination maximum value.

The link scheduler 980 may assign a link activation time of the link to which the channel is assigned by the channel assignment unit 970.

Also, the WMN scheduling system based on the bio-inspired algorithm may further include a neighbor information acquiring unit 920 and a local statistic unit 960. Accordingly, the local statistic unit 960 may acquire information about neighbor nodes from the neighbor information acquiring unit 920, may generate statistic information, and may provide the generated statistic information to the channel assigning unit 970.

Also, the WMN scheduling system based on the bio-inspired algorithm may further include a link weight calculating unit 930. The link weight calculating unit 930 may calculate a link weight using a transmission frame weight and a priority frame weight. The channel assignment determination maximum value statistic unit 950 may update the channel assignment determination maximum values based on the link weight calculated by the link weight calculating unit 970.

As such, the WMN scheduling method and a system therefor according to the exemplary embodiment of the inventive concept may improve spectral efficiency through efficient channel assignment. Also, the WMN scheduling method and a system therefor may meet the delay request condition for frame transmission by giving the scheduling priority to the priority frames. Also, because the WMN scheduling method may be a distributed scheduling method based on the bio-inspired algorithm, it may be easy to be later applied to a routing algorithm.

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Alternatively, the processing unit may have a different processing configuration, such as a parallel processor.

Software may include computer programs, codes, instructions or one or more combinations thereof and configure a processing unit to operate in a desired manner or independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and be stored or executed in a dispersion manner. Software and data may be recorded in one or more computer-readable storage media.

The methods according to the above-described exemplary embodiments of the inventive concept may be recorded in computer-readable media including program instructions to implement various operations embodied by a computer. The media may also include, alone or in combination with the program instructions, data files, data structures, and the like. The program instructions recorded in the media may be designed and configured specially for the exemplary embodiments of the inventive concept or be known and available to those skilled in computer software. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules to perform the operations of the above-described exemplary embodiments of the inventive concept, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. A wireless mesh network (WMN) scheduling method based on a bio-inspired algorithm, comprising:
updating statistic information about channel occupancy statuses and statistic information about channel assignment determination maximum values through an ant packet;
assigning a channel, which meets secondary interference constraint, using the channel assignment determination maximum values and assigning a link activation time; and
repeatedly performing the processing from the updating of the statistic information until the channel is assigned to all links of a node.

2. The WMN scheduling method of claim 1, wherein the updating of the statistic information about the channel occupancy statuses and the statistic information about the channel assignment determination maximum values through the ant packet comprises:
calculating the channel assignment determination maximum values;
acquiring the channel occupancy statuses and the channel assignment determination maximum values of nodes within three hops through the ant packet; and
updating the statistic information about the channel occupancy statuses and the statistic information about the channel assignment determination maximum values.

3. The WMN scheduling method of claim 1, wherein the assigning of the channel, which meets the secondary interference constraint, using the channel assignment determination maximum values and the assigning of the link activation time comprises:
determining whether the channel is assigned to the greatest value in the statistic information about the channel assignment determination maximum values;
determining whether there is the channel which meets the secondary interference constraint;
assigning the channel, which meets the secondary interference constraint, a link having the maximum assignment determination maximum value;
assigning the link activation time on a frame-by-frame basis; and
transmitting frames.

4. The WMN scheduling method of claim 1, wherein the assigning of the channel, which meets the secondary interference constraint, using the channel assignment determination maximum values and the assigning of the link activation time comprises:
assigning the channel based on a link weight.

5. The WMN scheduling method of claim 4, wherein the assigning of the channel based on the link weight comprises:
calculating a transmission frame weight and a priority frame weight;
calculating a link weight based on the transmission frame weight and the priority frame weight; and
updating the link weight according to a change in a beacon interval period and a change in the number of frames which are accumulated in queues.

6. A wireless mesh network (WMN) scheduling system based on a bio-inspired algorithm, comprising:
an ant generating and analyzing unit configured to generate and analyzing an ant;
a channel occupancy status statistic unit configured to update information about channel occupancy statuses through the ant generating and analyzing unit;
a channel assignment determination maximum value statistic unit configured to calculate and update channel assignment determination maximum values;
a channel assigning unit configured to a channel, which meets secondary interference constraint, using the channel occupancy statuses and the channel assignment determination maximum values; and
a link scheduler configured to assign a link activation time of a link to which the channel is assigned by the channel assigning unit.

7. The WMN scheduling system of claim 6, further comprising:
a local statistic unit configured to acquire information about neighbor nodes, generate statistic information, and provide the statistic information to the channel assigning unit.

8. The WMN scheduling system of claim 6, further comprising:
a link weight calculating unit configured to calculate a link weight using a transmission frame weight and a priority frame weight,
wherein the channel assignment determination maximum value statistic unit updates the channel assignment determination maximum values based on the link weight calculated by the link weight calculating unit.

9. The WMN scheduling system of claim 6, wherein the channel assignment determination maximum value statistic unit calculates the channel assignment determination maximum values, acquires the channel assignment determination maximum values of nodes within three hops through an ant packet, and updates statistic information about the channel assignment determination maximum values.

10. The WMN scheduling system of claim 6, wherein the channel assigning unit verifies whether the channel is assigned to the greatest value in the channel assignment determination maximum value statistic unit, verifies whether there is the channel which meets the secondary interference constraint, and assigns the channel, which meets the secondary interference constraint, to a link having the channel assignment determination maximum value.
